(19) United States
(12) Patent Application Publication
(10) Pub. No.: US 2021/0161134 A1
(43) Pub. Date: Jun. 3, 2021

(54) HERBICIDE AND METHOD OF APPLYING A HERBICIDE

(71) Applicants: David Sands, Bozeman, MT (US); Wayne Vinje, Bozeman, MT (US)

(72) Inventors: David Sands, Bozeman, MT (US); Wayne Vinje, Bozeman, MT (US)

(21) Appl. No.: 17/165,858

(22) Filed: Feb. 2, 2021

Related U.S. Application Data
(63) Continuation of application No. 15/236,897, filed on Aug. 15, 2016, now abandoned.
(60) Provisional application No. 62/205,140, filed on Aug. 14, 2015.

(51) Int. Cl. A01N 37/44

(52) U.S. Cl. CPC A01N 37/44

(57) ABSTRACT

A herbicide and a method for killing targets plants is disclosed. The herbicide includes first and second amino acids applied to the leaves of the plant. The first and second amino acids, when combined interfere with at least one biological process.

### CROSS-REFERENCE TO RELATED APPLICATION(S)

This application is a continuation of U.S. patent application Ser. No. 16/417,487, filed on May 20, 2019. Application Ser. No. 16/417,487 claims the benefit of U.S. Provisional Application No. 62/205,140, filed on Aug. 14, 2015. The entire disclosure of the above applications are incorporated herein by reference.

### FIELD

The present disclosure relates to herbicides for plants and more particularly herbicides for plants including at least one amino acid.

### BACKGROUND

This section provides background information related to the present disclosure, which is not necessarily prior art. This section provides background information related to the present disclosure that is not necessarily prior art. Most modern chemical herbicides inhibit a single biosyntheticenzyme in the target plant. This enzyme inhibition renders the plant incapable of producing metabolites essential for plant growth or defense and eventually leads to death of the plant. Glyphosate, sulfonylureas, imidazolinones, 1, 2, 4-triasol and pyrimidines are classic examples of herbicides that interfere with amino acid biosynthesis. Glyphosate inhibits 5′ enol pyruvyl shikimate 3-phosphate synthase (EPSP), the key enzyme in the shikimic acid pathway (Amrhein, 1986). Another target enzyme, acetolactate synthase (ALS) is a unique herbicide target in that several structurally differing compounds inhibit the enzyme (sulfonylureas, imidazolinones, 1, 2, 4-triasol pyrimidines). The activity of ALS is also inhibited by its own biosynthetic end-products (valine and/or isoleucine) efficiently regulating the balanced production of branched amino acids. Accumulation of a single end-product in a branched biosynthetic pathway may lead to shutdown of the entire pathway. For example, isoleucine inhibits ALS preventing not only biosynthesis of isoleucine but also biosynthesis of valine, leucine, and the essential vitamin, pantothenic acid. Accumulation of both isoleucine and valine has a synergistic effect further reducing the activity of the enzyme.

Feedback inhibition of biosynthetic enzymes in other amino acid pathways is also well documented. In higher plants and bacteria, lysine, threonine, and methionine are synthesized in a branched pathway from aspartate (Bryan, 1980; Umbarger and Davis, 1962). The activity of the first enzyme in this pathway (aspartate kinase) is regulated by the concentrations of lysine and threonine. The activity of the third enzyme in the pathway is regulated by the concentration of methionine (Green and Phillips, 1974). Hence, the exogenous application of one of the end product amino acids leads to repression of the entire pathway, resulting in depletion of the other two amino acids, and eventual starvation.

### SUMMARY

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

This section provides a general summary of the disclosure, and is not a comprehensive disclosure of its full scope or all of its features. According to the present teaching, a herbicide and a method for killing targets plants is disclosed. The herbicide includes first and second amino acids applied to the leaves of the plant. The first and second amino acids, when combined interfere with at least.

According to another teaching of the present disclosure, the pair of amino acids inhibit aspartokinase in a plant. In this regard, the pair of amino acids can include two of lysine, threonine, and methionine.

According to another teaching of the present disclosure, the pair of amino acids inhibit at least one biological process in a plant. The pair of amino acids includes a mixture of lysine, threonine.

According to another teaching of the present disclosure, the pair of amino acids inhibit at least one biological process in a plant. The pair of amino acids includes a mixture of lysine, threonine having a concentration of 4 mM.

According to another teaching of the present disclosure, the pair of amino acids inhibits at least one biological process in a plant. The pair of amino acids comprises a mixture amino acids having a concentration of between 20-50% lysine and the balance of the amino acid mixture being the balance threonine. It is also envisioned that the concentration of lysine may have other ranges of values including 20-40%, 20-35%, 20- 30%, 20-25%, 25-50%, 30-50%, 35-50%, 40-50%, and 45-50%.

According to another teaching of the present disclosure, the pair of amino acids inhibits at least one biological process in a plant. The pair of amino acids comprises a mixture amino acids having a concentration of 20-50% threonine and the balance of the amino acid mixture being lysine. It is also envisioned that the concentration of threonine may have other ranges of values including 20-40%, 20-35%, 20-30%, 20-25%, 25-50%, 30-50%, 35-50%, 40-50%, and 45-50%.

According to another teaching of the present disclosure described above is the pair of amino acids, which inhibit at least one biological process in a plant. Included with the pair of amino acids is a salt.

According to another teaching of the present disclosure described above is the pair of amino acids, which inhibit at least one biological process in a plant. Included with the pair of amino acids is a salt, with the salt having cations being potassium or ammonia ions.

According to another teaching of the present disclosure described above is the pair of amino acids, which inhibit at least one biological process in a plant. Included with the pair of amino acids is a salt, with the salt having a concentration of between 0.2 and 0.5 M.

According to another teaching of the present disclosure as described is the pair of amino acids, which inhibit at least one biological process in a plant. Included with the pair of amino acids is a salt, with the salt having cations being potassium or ammonia ions.

According to another teaching of the present disclosure as described is the pair of amino acids, which inhibit at least one biological process in a plant. Included with the pair of amino acids is a fertilizer.

According to another teaching of the present disclosure, a method for killing a plant included applying a herbicide having a pair of amino acids configured to inhibit a biological process in a plant is disclosed. The herbicide can include a pair of amino acids that is two of lysine, threonine, and methionine.

According to another teaching of the present disclosure, a method for killing a plant included applying a herbicide to the plant, where the herbicide includes pair of amino acids configured to inhibit at least one biological process in a plant. The pair of amino acids includes a mixture of lysine, threonine.

According to another teaching of the present disclosure, a method for killing a plant included applying a herbicide to the plant, where the herbicide includes a mixture of a pair of amino acids having a concentration of between 20-50% lysine and the balance of the amino acid mixture being the balance threonine.

According to another teaching of the present disclosure, a method for killing a plant included applying a herbicide to the plant, where the herbicide includes a mixture amino acids having a concentration of 20-50% threonine and the balance of the amino acid mixture being lysine.

According to another teaching of the present disclosure, a method for killing a plant included applying a herbicide to the plant, where the herbicide is configured to inhibit aspartokinase and includes a pair of amino acids and a salt.

According to another teaching of the present disclosure, a method for killing a plant included applying a herbicide to the plant, where the herbicide has a pair of amino acids and a salt, with the salt having cations being potassium or ammonia ions.

According to another teaching of the present disclosure, a method for killing a plant includes applying a herbicide to the plant, where the herbicide has the pair of amino acids which inhibit at least one biological process in a plant. Included with the pair of amino acids is a salt, with the salt having cations being potassium or ammonia ions.

According to another teaching of the present disclosure, a method for killing a plant includes pre-emergent or post-emergent applying a herbicide to the plant, where the herbicide has the pair of amino acids which inhibit at least one biological process in a plant. Alternatively, seed coating (to stimulate germ, or to protect from herbicides and/or pathogens can include the pair of amino acids.

According to another teaching of the present disclosure, a method for killing a plant includes pre-emergent or post-emergent applying a herbicide to the plant, where the herbicide has the pair of amino acids which inhibit at least one biological process in a plant to reverse herbicides by providing end product amino acids of ALS and Aromatic pathways.

The embodiments and the examples described herein are exemplary and not intended to be limiting in describing the full scope of compositions and methods of the present technology. Equivalent changes, modifications and variations of embodiments, materials, compositions and methods can be made within the scope of the present technology, with substantially similar results.

### DRAWINGS

The drawings described herein are for illustrative purposes only of selected embodiments and not all possible implementations, and are not intended to limit the scope of the present disclosure.

FIG. 1 represents Canada thistle groups treated with a pair of amino acids;

FIG. 2 represents a single amino acid effecting Kudzu;

FIG. 3 represents a single amino acid effect against Rush Skeleton weed; and

FIG. 4 represents the effect of a pair of amino acids to Field Bindweed.

Corresponding reference numerals indicate corresponding parts throughout the several views of the drawings.

### DETAILED DESCRIPTION

According to the present teachings, a herbicide and a method for killing targets plants is disclosed. The herbicide includes first and/or second amino acids that are applied to the leaves of the plant. The first and second amino acids, when combined interfere with at least one biologic process within the plant. Generally, L-Lysine has been found to kill dandilions, canadian thistle, hoary alssum, leafy supruge, morning glories, common yarroen hounds toungem rush skeleton, wild rubarb. L-methionine has been found to kill kudzu, spotted knapweed, poa anna, and eurasian milfoil and important aquatic weeds, It is expected amino acids will kill tansy, goldenrod and hemlock.

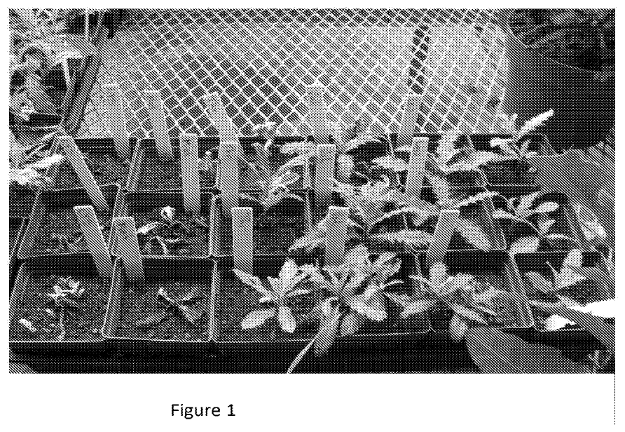

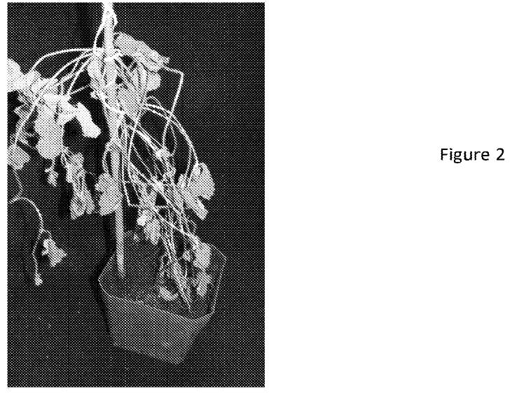

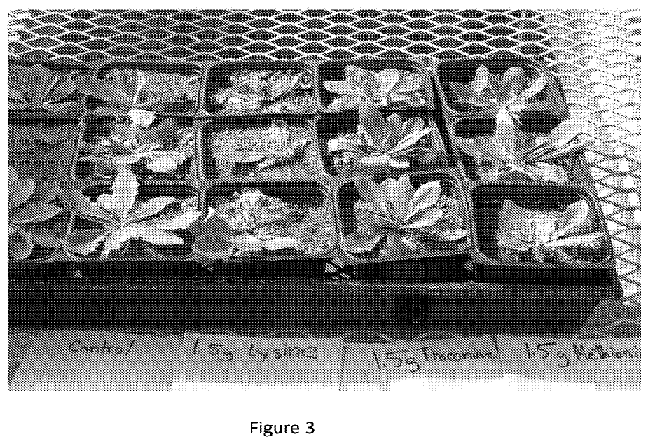

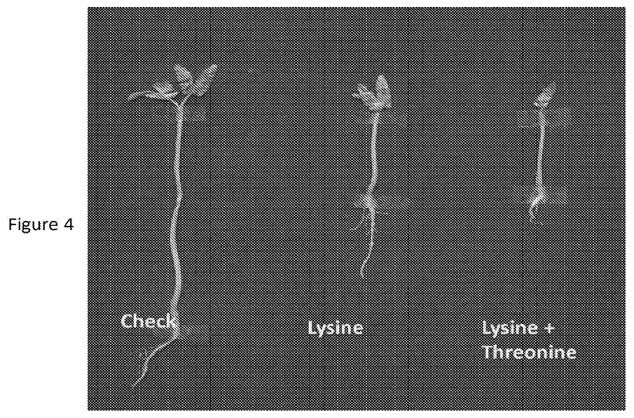

FIGS. 1-4 represent the effect of amino acids on the growth of various weed. In this regard, FIG. 1 represents Canada thistle groups treated with amino acids lysine and methionine are on left, with control far right. As can be seen, the application of single amino acids to thistle kills the plant. Combinations of any two of lysine, methionine and threonine significantly increases the kill rate for thistle as well as dandelions. FIG. 2 represents Methionine effecting Kudzu. Kudzu is affecting 7,000,000 acres in US and represents an alternate host for soybean rust. FIG. 3 represents Lysine effect against Rush Skeleton weed; and FIG. 4 represents the effect of a combination of amino acids to field bindweed.

Optionally, the single or pair of amino acids can inhibit aspartokinase in a target weed or plant. In this regard, a herbicide to kill dandelions and thistle can include the pair of amino acids including two of lysine, threonine, and methionine. According to another teaching of the present disclosure, the pair of amino acids inhibit at least one biological process in a plant. The pair of amino acids includes a mixture of lysine, threonine. The pair of amino acids includes a mixture of lysine, threonine having a concentration of 2-4 mM.

Other weeds can be killed using amino acids and pairs of amino acids, these include, by way of non-limiting example, the weed Field Bindweed is killed by the amino acid Lysine. The weed hounds tongue is killed by at least the amino acid Valine. Spotted Knapweed is killed by a pair of amino acids including valine and tryptophan. The weed leafy spurge can be killed with at least a pair of amino acids include lysine and tryptophan. The weed Kudzu is killed by at least the amino acid Methionine. The weed rush skeleton is killed by the amino acid Lysine.

Generally, the pair of amino acids inhibits at least one biological process in a plant. The pair of amino acids comprises a mixture amino acids having a concentration of between 20-50% lysine and the balance of the amino acid mixture being the balance threonine. It is also envisioned that the concentration of lysine may have other ranges of values including 20-40%, 20-35%, 20-30%, 20-25%, 25-50%, 30-50%, 35-50%, 40-50%, and 45-50%.

The pair of amino acids in combination or alone inhibit at least one biological process in a plant. The herbicide can include 20-50% of a single amino acid or a mixture of amino acids configured to inhibit a biological process. Optionally, the mixture of amino acids can have a concentration of 20-50%, threonine and the balance of the amino acid mixture being lysine. It is also ranges of values including 20-40%, 20-35%, 20-30%, 20-25%, 25-50%, 30-50%, 35-50%, 40-50%, and 45-50%. Optionally, included with the pair of amino acids is a salt, which can have cations being potassium or ammonia ions and/or can have a concentration of between 0.2 and 0.5 M. Included with the pair of amino acids can be a fertilizer.

Preferably, a herbicide can be formed of a pair of amino acids selected from the group of lysine, threonine, and methionine, valine, and tryptophan. While not as efficacious, alternatively, the herbicide can include a single amino acid selected from the list of lysine, threonine, and methionine, valine, and tryptophan. Alternatively, the herbicide can include amino acids selected from the list of lysine, threonine, and methionine, valine, tryptophan and mixtures thereof. The mixtures of amino acids should be preferably be in a ratio which oversupplies the at least one amino acid within at least one specific biological process so as to cause the plant or fungus to use up all of at least one amino acid or nutrient, thus causing the plant to die from the deficit of the amino acid or nutrient.

According to a method of the present teachings, to kill a plant, a herbicide having at least one amino acid configured to inhibit a biological process in a plant is applied of the leaves of the plant. By way of example, at least one of lysine, threonine, and methionine can be applied to the leaves of a dandelion or thistle plant to kill the plant. The amino acid can be applied in granular form having a binder, or as a liquid with combined with water. In the liquid form, the amino acid can include a surfactant to improve wetting of the leaf.

Optionally, to kill a plant, a herbicide including a pair of amino acids configured to inhibit a first biological process in a plant is applied of the leaves of the plant. Preferably, a herbicide can be formed of a pair of amino acids selected from the group of lysine, threonine, and methionine, valine, and tryptophan can be applied to the leaves of the plant. While not as efficacious, alternatively, the herbicide can include a single amino acid selected from the list of lysine, threonine, and methionine, valine, and tryptophan can be applied to the leaves of the plant. Alternatively, the herbicide can include amino acids selected from the list of lysine, threonine, and methionine, valine, tryptophan and mixtures thereof can be applied to the leaves of the plant. Preferably, a mixture of two of lysine, threonine, and methionine can be applied to the leaves of a dandelion or thistle plant to kill the plant. The amino acid mixture can be applied in granular form having a binder, or as a liquid when combined with water. In the liquid form, the amino acid can include a surfactant to improve wetting of the leaf.

According to another teaching a method for killing a plant can include applying a herbicide to the plant, where the herbicide includes pair of amino acids configured to each inhibit separate different biological processes in the plant. The herbicide can include 20-50% of a mixture of amino acids configured to inhibit the separate biological processes by oversupplying the at least one amino acid within at least one specific biological process so as to cause the target plant to use up all of at least one amino acid or nutrient, thus causing the plant to die from the deficit of the amino acid or nutrient.

Optionally, the mixture of amino acids can have a concentration of 20-50%, of two of lysine, threonine, and methionine and the balance of the amino acid mixture being an amino acid to inhibit a second biological process. It is also ranges of values including 20-40%, 20-35%, 20-30%, 20-25%, 25-50%, 30-50%, 35-50%, 40-50%, and 45-50%. Optionally, included with the pair of amino acids is a salt, which can have cations being potassium or ammonia ions and/or can have a concentration of between 0.2 and 0.5 M. Included with the pair of amino acids can be a fertilizer to assist in the growth of non-affected species such as grass.

According to another teaching of the present disclosure, a method for killing a dandelions an thistle included applying a herbicide to the plant, where the herbicide includes a mixture of a pair of amino acids having a concentration of between 20-50% lysine and the balance of the amino acid mixture being the balance threonine.

According to another teaching of the present disclosure, a method for killing a plant includes applying a herbicide to the plant, where the herbicide includes a mixture amino acids having a concentration of 20-50% threonine and the balance of the amino acid mixture being lysine. The method includes mixing the amino acids in a dry form, and afterward mixing the amino acid mixture into the water. This amino acid water mixture is then applied with a spray bottle onto a selected area or plant for the killing of weeds. Optionally, the herbicide is configured to inhibit aspartokinase and includes the pair of amino acids and optionally a salt and or a surfactant. The salt can have cations being potassium or ammonia ions.

According to another teaching of the present disclosure, a method for killing a plant includes pre-emergent or post-emergent applying a herbicide to the plant, where the herbicide has a single amino acid or a pair of amino acids which inhibit at least one biological process in a plant. Alternatively, seed coating (to stimulate germ, or to protect from herbicides and/or pathogens can include the pair of amino acids.

According to another teaching of the present disclosure, a method for killing a plant includes pre-emergent or post-emergent applying a herbicide to the plant, where the herbicide has the pair of amino acids which inhibit at least one biological process in a plant to reverse herbicides by providing end product amino acids of ALS and Aromatic pathways.

The embodiments and the examples described herein are exemplary and not intended to be limiting in describing the full scope of compositions and methods of the present technology. Equivalent changes, modifications and variations of embodiments, materials, compositions and methods can be made within the scope of the present technology, with substantially similar results.

The headings and sub-headings used herein are intended only for general organization of topics within the present disclosure, and are not intended to limit the disclosure of the technology or any aspect thereof. In particular, subject matter disclosed in the “Introduction” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition or method.

The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the compositions and methods of this technology and, unless explicitly stated otherwise, are not intended to be a representation that given embodiments of this technology have, or have not, been made or tested. Equivalent changes, modifications and variations of some embodiments, materials, compositions and methods can be made within the scope of the present technology, with substantially similar results.

As used herein, the words “preferred” or “preferable” refer to embodiments of the technology that afford certain benefits, under certain circumstances. However, other embodiments may also be desirable, under the same or other circumstances. Furthermore, the recitation of one or more desired embodiments does not imply that other embodiments are not useful, and is not intended to exclude other embodiments from the scope of the technology.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components or process steps, the present technology also specifically includes embodiments consisting of, or consisting essentially of, such materials, components or processes excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

Disclosure of values and ranges of values for specific parameters (such as temperatures, molecular weights, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that parameter X may have a range of values from about A to Z values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. The description and specific examples in this summary are intended for purposes of illustration only and are not intended to limit the scope of the present disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A herbicide comprising:
one of a first amino acid and a first and a second amino acid, the first and second amino acids, combined interfere with at least one biologic process within one of dandelions, and Canadian thistle.

2. The herbicide according to claim 1 wherein the one of a first amino acid and a first and a second amino acid inhibit aspartokinase in a target weed or plant.

3. The herbicide according to claim 1 wherein the one of a first amino acid include one of lysine, threonine, and methionine.

5. The herbicide according to claim 1 wherein the first and second amino acids include a mixture of lysine, threonine.

6. The herbicide according to claim 1 wherein the first and second amino acids include a mixture lysine, threonine having a concentration between 2 and 4 mM.

7. The herbicide according to claim 1 wherein the first and second amino acids comprises a mixture amino acids having a concentration of between 20-50% lysine and the balance of the amino acid mixture being the balance threonine.

8. The herbicide according to claim 1 wherein the herbicide contain first and second amino acids comprising a concentration of selected from the group of 20-40%, 20-35%, 20-30%, 20-25%, 25-50%, 30-50%, 35-50%, 40-50%, and 45-50%.

9. The herbicide according to claim 1 comprising a salt, which can have cations being one of potassium and ammonia ions.

10. The herbicide according to claim 9 having a concentration of between 0.2 and 0.5 M.

11. The herbicide according to claim 1 comprising a fertilizer.

12. The herbicide according to claim 1 consisting of an amino acid selected from the group of lysine, threonine, and methionine, valine, and tryptophan.

13. The herbicide according to according to claim 1 consisting of a pair of amino acids selected from the group of pairs of two of lysine, threonine, and methionine, valine, and tryptophan.

14. The herbicide according to according to claim 1 wherein the first amino acid oversupplies the first amino acid within at least one specific biological process so as to cause the plant to use up all of at least one amino acid, thus causing the plant to die from the deficit of the amino acid.

15. The herbicide according to claim 1 further comprising a surfactant to improve wetting of a target plant leaf.

16. A method of killing a target plant comprising:
applying a herbicide comprising an amino acid to the target plant the first amino acid oversupplies the first amino acid within at least one specific biological process so as to cause the plant to use up all of at least one amino acid, thus causing the plant to die from the deficit of the amino acid.

17. The method according to claim 16, wherein applying a herbicide is spraying a liquid on the leaves of the plant.

18. A method of killing a target plant comprising:
applying a herbicide comprising a pair amino acid to the target plant the pair of amino acids oversupplying at least a first amino acid within at least one specific biological process so as to cause the plant to use up all of at least a third amino acid, thus causing the plant to die from the deficit of the amino acid.

19. The method according to claim 18, wherein applying a herbicide is spraying a liquid on the leaves of the plant and wherein the pair of amino acids oversupplying at least a second amino acid within at least a second specific biological process so as to cause the plant to use up all of at least a fourth amino acid, thus causing the plant to die from the deficit of the third amino acid.
